(19) United States
(12) Patent Application Publication
(10) Pub. No.: US 2025/0018402 A1
(43) Pub. Date: Jan. 16, 2025

(54) ELECTROSTATIC BINNING PRECIPITATOR

(71) Applicant: Lyten, Inc., San Jose, CA (US)

(72) Inventor: Kent Riley Child, Fredericksburg, TX (US)

(21) Appl. No.: 18/221,403

(22) Filed: Jul. 13, 2023

(51) Int. Cl. B03C 3/02; B03C 3/06; B03C 3/49; B03C 3/74

(52) U.S. Cl. CPC B03C 3/025; B03C 3/06; B03C 3/49; B03C 3/743

(57) ABSTRACT

An electrostatic binning precipitator separates solid particles from gases and vapors and sort the solid particles based upon size, density, or morphology. The electrostatic binning precipitator includes a precharger, electrostatic cells, and optionally a heat exchanger. The precharger applies a negative charge to the solid particles that are then collected in one of the electrostatic cells. Each of the electrostatic cells has an independent power supply that applies a voltage to center negative electrodes that are partially surrounded by grounded concave shells. Lower voltage electrostatic cells collect smaller solid particles and higher voltage electrostatic cells collect larger solid particles. The solid particles are moved from the shells into collection hoppers. Gases and vapors can optionally flow into a heat exchanger that can condense these particles into liquids that are collected in reservoirs. The collected solid particles and liquids can be used for industrial applications or safely disposed.

### BACKGROUND

Global climate change has become one of the most profound issues facing our society. Climate change generally refers to long-term shifts in temperatures and weather patterns. The significant rate of increase in temperature change since the modern industrial era, however, has led to the acknowledgment that anthropogenic activities have contributed to global climate change in the last century. This is primarily due to the burning of fossil fuels like coal, oil, and natural gas. Combustion of these fossil fuels produces heat-trapping gases, referred to as greenhouse gases. Greenhouse gases that are trapped in the atmosphere act like a heat insulator, trapping the sun's heat and raising Earth's surface temperatures. Although heat insulating gases can be found naturally in low proportions in Earth's atmosphere, the proportions have increased significantly since the beginning of the last century.

Studies conducted by the United Nations have shown that greenhouse gas proportions in our atmosphere are at their highest levels in 2 million years, and emissions of more and more greenhouse gases continue to increase, which leads to global warming, which has in turn lead to the situation that the Earth is now about 1.1° C. warmer than it was 150 years ago. While scientists and government reviewers generally agree that limiting this temperature rise to no more than 1.5° C. will help avoid disastrous climate impacts and maintain a livable climate, the science suggests that at current rates, the Earth's temperature is projected to increase by a further 2.1° C. by the end of this century. The opportunity for mankind to stem further increases in global temperatures is thus slipping away quickly unless deliberate action is taken now to reduce emissions of greenhouse gases into the atmosphere.

Activities chiefly associated with emissions of greenhouse gases are the burning of fossil fuels for electric power generation, and combustion of fossil fuels (e.g., gasoline) for transportation. Virtually all sectors of heavy industry, from energy production, manufacturing, mining, transport, construction, agriculture and land use, etc. are major emitters of greenhouse gases.

As mentioned above, the two industries that are chiefly associated with the emission of greenhouse gases are (1) electric power generation and (2) transportation. Both industries have traditionally relied on combustion of fossil fuels to generate electrical power, and provide motive power for cars, trucks, busses, heavy equipment, and so on. The combustion of fossil fuels (i.e., coal, oil, and natural gas), is deemed to be the largest single contributor to global climate change, accounting for over 75% of greenhouse gas emissions and accounting for nearly 90% of all carbon dioxide emissions.

Traditional fossil fuel burning plants are highly inefficient, wastefully burning fossil fuel to generate steam, which is then wastefully used to generate electricity. Internal combustion engines (ICE) are also inefficient in that they convert the chemical energy stored in the fuel into thermal energy via combustion, which is then converted into mechanical energy that is then used for motive power.

As a viable alternative to combustion systems, fuel cells generate power through electrochemical reactions, rather than through combustion. A typical proton exchange fuel cell combines hydrogen and oxygen to generate electricity, heat, and water. Various other fuel cells that can use fuels other than hydrogen gas have emerged as a clean energy source that are capable of highly efficient energy conversion.

Significantly, fuel cells differ from batteries in that they require a continuous source of fuel and oxygen to sustain the electrochemical reaction. Fuel cells can produce electricity continuously for as long as fuel and oxygen are supplied. Fuel cells come in various different types, such as phosphoric acid fuel cells, solid acid fuel cells, alkaline fuel cells, and solid oxide fuel cells.

Of the various types of fuel cells, solid oxide fuel cells (SOFCs) have shown great potential for providing efficient power generation for industrial, residential, transportation, and military applications. Unlike combustion-based power generators, SOFCs convert the chemical energy of fuel directly into electrical energy, without incurring the inefficiencies associated with steam generation and the inefficiencies associated with conversion of mechanical energy to electrical energy. The simplicity of fuel cell systems yield the potential for high efficiency power generation.

One barrier to the widespread use and commercialization of SOFCs, however, has been the expensive manufacturing process, which increases the overall price of SOFC systems, sometimes leading to impracticalities. More specifically, existing fuel cell fabrication processing is time consuming and requires large amounts of energy. Unfortunately, such large amounts of energy use contributes to the creation of harmful gases that exacerbate present climate change issues, and prevent SOHCs and similar fuel cells from being a truly green energy source needed to combat global warming trends.

Dissociating reactors can convert hydrocarbons such as methane (CH₄) into hydrogen (H) and pure solid carbon (C) and these carbon particles can be used to fabricate SOHCs. It can be important to fabricate SOHCs using carbon particles that are uniform in size and morphology. Current carbon particle collection systems do not separate the material into uniform size and morphologies. This makes the collected carbon particle product very hard to post process because the collected carbon particles are a very random mix of particle sizes, particles cluster sizes, and morphologies.

What is needed is an electrostatic binning precipitator that can be tuned to selectively separate out solid particles and sort these particles based on size, density, and/or morphology. The collected and sorted solid carbon particles can be uniform in size, density, and/or morphology. The collected solid carbon particles can be used to fabricate SOHCs, composites, elastomers, sensors, or other applications.

### BRIEF SUMMARY OF THE INVENTION

The present invention relates to an electrostatic precipitator designed to separate and collect solid particles from gases and vapors that can be produced by a dissociating reactor or another solid particle source. Dissociating reactors are commonly used to convert hydrocarbon fluids like methane into hydrogen and carbon. The hydrogen gas can be separated from the reactor's output, while the remaining output may contain solid carbon particles, hydrocarbon liquids and vapors, and other gases. These outputs can be further processed using an electrostatic cell binning precipitator, which separates and collects particles of different sizes into separate collection bins and segregates different liquids into separate reservoirs. The separated particles and liquids can then be utilized for fabrication materials, fuels, or other purposes.

The electrostatic binning precipitator comprises three main sections housed within an elongated tubular structure: a pre-charger portion, an electrostatic binning portion, and a heat exchanger portion. The pre-charger and binning portions of the precipitator can be heated to a temperature range of approximately 350° C. to 600° C. to ensure immediate vaporization of incoming liquids at the precipitator's inlet. This vaporization process is crucial to prevent liquids from getting trapped in the electrostatic bins. Particles such as carbon, hydrocarbon vapors, and other gases flow into the inlet of the electrostatic binning precipitator at a high velocity due to the small cross-section of the inlet.

As the particles including solid particles, vapors, and gases enter the pre-charger portion, their velocity decreases due to the larger cross-section of this section. In the pre-charger, the solid particles become negatively charged and are then collected by the electrostatic precipitator (ESP). The pre-charger portion consists of straight electrodes spanning the width of the precipitator housing, which are connected to a direct current voltage source. The negative pole of the voltage source is connected to exposed conductor electrodes, while the positive pole is connected to insulated conductor electrodes. The exposed negative electrodes are arranged parallel to each other, defining a negative electrode plane perpendicular to the precipitator housing's center axis. The shielded wire positive electrodes are positioned downstream of the negative electrodes, forming a positive electrode plane parallel to the negative electrode plane and perpendicular to the precipitator housing's center axis. When a voltage is applied to the electrodes, an electric field is generated between the negative and positive electrodes within the precipitator housing. Multiple sets of pre-charger electrodes can be present in this section of the precipitator. In certain embodiments, the voltage applied to the electrodes can be −10,000 volts direct current (VDC), while other suitable voltages such as −5,000 VDC to −30,000 VDC may be used.

Upon entering the pre-charger portion, the solid particles can acquire a negative charge from the negative electrodes. The negatively charged solid particles are then attracted to and accelerated towards the downstream positive electrodes. Subsequently, the negatively charged particles, vapors, and gases pass between the electrodes and exit the pre-charger portion, proceeding into the electrostatic binning portion of the precipitator.

The electrostatic cell portion of the precipitator can consist of multiple sequential electrostatic cells along the length of the precipitator housing arranged in multiple parallel flow paths. Each electrostatic cell comprises negatively charged center electrode rods and positively charged conductive shells. Separate voltage sources can be connected to each sequential electrostatic cell or set of parallel electrostatic cells. The negative electrode rods are elongated rods extending across the height of the precipitator housing and into a collection bin. The positively charged conductive shells can have concave cylindrical surfaces that partially surround the center electrode rod(s) and also extend across the height of the precipitator housing and into the collection bin. The shells and slots of the electrostatic cells can be vertically oriented.

The separated negatively charged solid particles can be deposited on the positively charged shells of the electrostatic shells. The electrostatic cells can also incorporate a scraper mechanism that can periodically sweep the solid particles from the shells into the collection bins at the bottom of the electrostatic cells. The scraper mechanism includes a structure having an outer edge that contacts the concave shell surfaces and an actuator that moves the scraper from the top of the shells down to the collection bins. Prior to performing the solid particle scraping, the flow through the precipitator is stopped and the electrostatic voltages for each electrostatic cell are turned off. The actuators then move the scrapers down in each electrostatic cell to transfer the collected particles from the shells into the collection bins. The actuators then reset the scrapers to their raised positions before resuming the particle flow through the precipitator and turning power to the electrostatic cells back on.

The solid particles can then be removed from the collection bins for use in other industrial applications. In some embodiments, the collection bins can be connected to a particle movement mechanism, such as a tube, to transport the collected particles to another location. The solid particles can be pure carbon that can be used to fabricate carbon products such as fuel cells, carbon parts, carbon panels, and other carbon structures.

The cross-section flow path through the precipitator housing into and out of the electrostatic cells comprises narrow vertical slots that have a smaller cross-section than the pre-charger portion. The flow path cross-sections increase in the center portions of the concave conductive shells of each electrostatic cell. The negatively charged solid particles, vapors, and gases accelerate in velocity through the narrow inlet slot and then decelerate in the electrostatic cells. The negatively charged solid particles are attracted to the positively charged conductive shells and repelled by the negatively charged center electrode(s). Some of the negatively charged solid particles can adhere to the positively charged conductive shells. The remaining solid particles, along with the vapors and gases, flow through narrow vertical slots between adjacent electrostatic cells to the subsequent electrostatic cell. This process repeats in each electrostatic cell, with some of the negatively charged solid particles attaching themselves to the positively charged conductive shells. Each electrostatic cell can have a different applied net voltage and can be configured to collect solid particles of a specific size, particularly carbon particles. The precipitator can be designed to remove all solid particles, allowing substantially only vapor and gases to exit. The last electrostatic cell can be configured with a higher net electrostatic voltage to collect any remaining solid particles.

The remaining vapor and gases flow from the electrostatic cell section into a heat exchanger to cool these fluids to a temperature below 300° C. The heat exchanger can consist of multiple water-cooled parallel plate baffles, each with offset flow holes. The vapors come into contact with the plates and condense into liquids. These liquids can flow to the bottom of each plate, where they are collected in separate reservoirs corresponding to each plate. Different liquids can be collected in each reservoir. The reservoirs can be connected to piping or tubing to transport the liquids out of the precipitator and to another location for use, processing, or disposal.

### BRIEF DESCRIPTION OF THE DRAWINGS

FIG. 1A illustrates an embodiment of an overall fuel cell production cycle.

FIG. 1B illustrates an embodiment of the fuel cell production cycle for producing efficient fuel cells.

FIG. 2A illustrates a top view of an electrostatic binning precipitator.

FIG. 2B illustrates a side view of the electrostatic binning precipitator.

FIG. 3A illustrates a cross section top view of an electrostatic binning precipitator 200.

FIG. 3B illustrates a cross section side view of the electrostatic binning precipitator 200.

FIG. 4 illustrates a perspective view and

FIG. 5 illustrates an electrical schematic diagram of a unipolar precharge stage.

FIG. 6 illustrates an electrical schematic diagram of a parallel flow path electrostatic collection bin precipitator.

FIG. 7 illustrates a top perspective cross section view of an embodiment of first collection bins in a parallel flow path precipitator system.

FIG. 8 illustrates a cross section side view of an embodiment of collection bins in a precipitator system.

FIG. 9A illustrates a cross section side view of an embodiment of an electrostatic precipitator system showing particle velocities.

FIG. 9B illustrates a cross section top view of an embodiment of an electrostatic precipitator system showing particle velocities.

FIG. 10A illustrates a cross section top perspective view of an embodiment a precipitator showing particle velocities through the first three electrostatic cells.

FIG. 10B illustrates a cross section side view of an embodiment a precipitator showing particle velocities through the first three electrostatic cells.

FIG. 11 illustrates a cross section side view of an embodiment of a liquid collecting heat exchanger.

FIG. 12 illustrates a perspective rear cross section view of a cooling plate of an embodiment of a liquid collecting heat exchanger.

### DETAILED DESCRIPTION

Fuel cells, including solid oxide fuel cells (SOFCs), offer great potential for efficient power generation in various applications by directly converting the chemical energy of fuel into electrical energy. The simplicity of SOFC systems provides the opportunity for high-efficiency power generation. However, current production methods can be time-consuming and energy-intensive, leading to high costs. Embodiments described herein relate to a fuel cell production process that achieves zero emissions and even offsets greenhouse gas emissions by completely and permanently dissociating methane that would otherwise be burned or released.

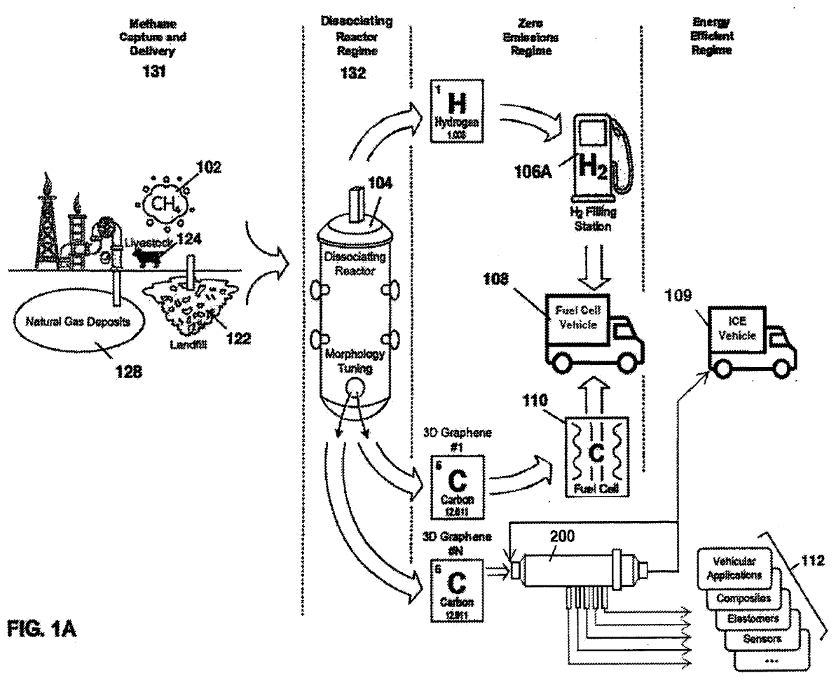

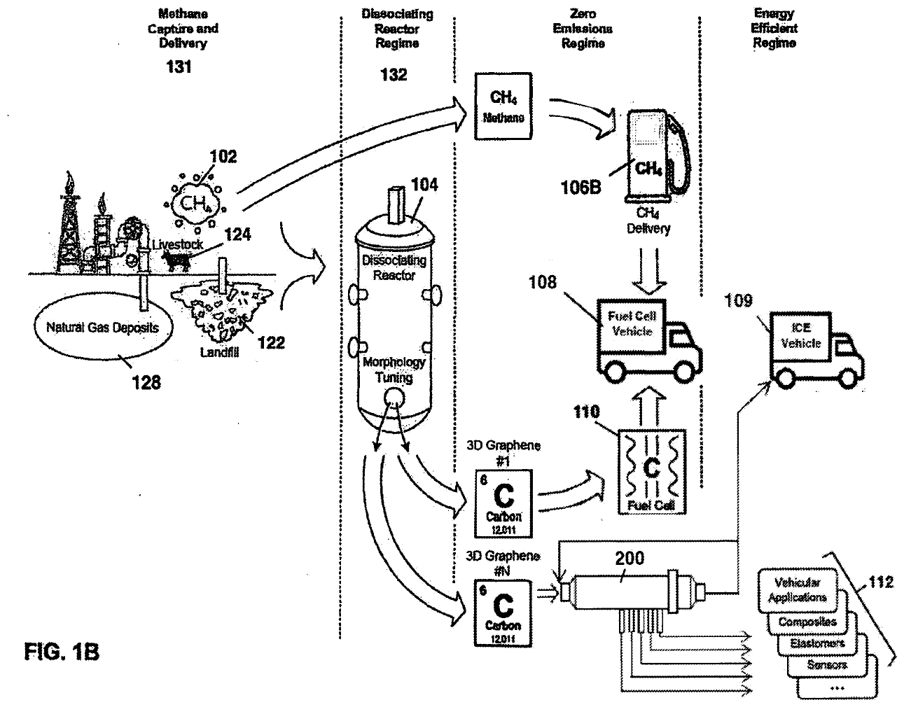

FIG. 1A illustrates an overall fuel cell production cycle for producing efficient fuel cells with zero or negative emission impacts, according to some embodiments. As depicted in FIG. 1A, the system comprises a source (or sources) of methane (CH₄) for processing in a dissociating reactor 104, resulting in the production of hydrogen (H) and carbon (C). The hydrogen can be utilized in a hydrogen filling station 106A to provide fuel for vehicles, such as the fuel cell electric vehicle 108 shown. The carbon produced in dissociating reactor 104 can be used to manufacture fuel cells 110. which supply electrical power to fuel cell vehicles 108. The dissociating reactor 104 also generates pure carbon solid particles of mixed sizes, which can be subjected to separation in a precipitator 200. The precipitator 200 segregates the mixed-size carbon particles into multiple collection bins, each collecting carbon particles within a specific size range. By sorting the carbon particles using the precipitator 200, the fabrication of carbon particle products can be optimized for specific applications that require carbon particles of uniform size or within a specific size range. The sorted carbon particles can find use in various carbon-containing applications 112, such as the production of SOFCs, carbon parts, carbon panels, and other structures.

In certain embodiments, a carbon sensor can detect solid carbon particles in the outlet flow from the precipitator 200. If any solid carbon particles are not collected by the electrostatic collection mechanism and are discharged from the precipitator 200, the solid carbon, gases and vapors can be returned to the inlet of the precipitator 200 for reprocessing. By recirculating or reprocessing these solid carbon particles, they are more likely to be collected by the electrostatic collection mechanism during a second pass through the precipitator 200.

In addition to pure solid carbon particles, the gases input to the precipitator may also contain liquids and vapors. The precipitator 200 can effectively separate and collect these liquids and vapors from the solid carbon particles and gases. Among these liquids and vapors are hydrocarbons that can be utilized as fuel for internal combustion engine vehicles 109. As depicted in FIG. 1A, methane undergoes processing and utilization that result in the generation of hydrogen that can be used as a direct fuel for a fuel cell, as well as useful solid carbon particles that can be used for various downstream applications.

As illustrated in the system, methane 102 can be obtained from natural sources, including natural gas deposits 128, landfills 122, and livestock 124. Natural gas typically consists of a mixture of light hydrocarbons such as methane, ethane, propane, butanes, pentanes, and other compounds (e.g., helium, nitrogen, CO2, etc.). Although the composition of natural gas varies due to various factors, methane is its primary component (usually constituting at least 90%). Significant amounts of methane can also be generated from decomposing materials found in landfills and garbage collection sites, as well as from livestock, such as cattle. Methane, being lighter than air, can be captured from these sources using gas recovery systems that enclose them. The methane capture and recovery stage 131 captures methane from the source or sources and delivers it to a dissociating reactor 104 for further processing.

In one embodiment, specific procedures and systems are employed to capture, mitigate, and/or repurpose the by-products produced during the fuel cell production process illustrated in FIG. 1A. For instance, carbon monoxide (CO) can be converted to carbon and oxygen using a catalytic converter. Similarly, carbon dioxide can be processed and treated to produce harmless gaseous components. For example, a catalytic converter can be used to oxidize carbon monoxide to carbon dioxide, or it can oxidize hydrocarbons to carbon dioxide and water. A three-way catalytic converter may be utilized to treat nitric oxide, nitrogen dioxide, and similar by-products, among other approaches.

In the embodiment depicted in FIG. 1A, the hydrogen produced by the dissociating reactor can directly power a fuel cell electric vehicle 108 through the hydrogen supplied by a hydrogen filling station 106A. Alternatively, other compounds can also be used to directly power the vehicle. FIG. 1B illustrates an embodiment of the fuel cell production cycle for producing efficient fuel cells wherein methane, instead of hydrogen, is employed as a fuel for the fuel cell electric vehicle 108. In this embodiment, the methane 102 produced in the capture stage 131 is captured and stored in an appropriate methane capture and storage facility. The methane is subsequently supplied to a methane delivery system, such as a methane filling station 106B, for use by the fuel cell electric vehicle 108.

It is important to note that for descriptive purposes, embodiments may be described in relation to either the system depicted in FIG. 1A or FIG. 1B, concerning the common components, even though only one figure or embodiment may be referenced.

In an embodiment, methane 102 undergoes processing in a dissociating reactor regime (or stage) 132, which includes a dissociating reactor 104. The dissociating reactor 104 comprises a microwave energy source that generates microwave energy and a field-enhancing waveguide connected to the microwave energy source. The field-enhancing waveguide has a first cross-sectional area and a second cross-sectional area, including a field-enhancing zone located between the two cross-sectional areas. The field-enhancing waveguide also consists of a plasma zone and a reaction zone. In certain embodiments, the second cross-sectional area is smaller than the first cross-sectional area, positioned farther away from the microwave energy source, and extends along a reaction length that forms the reaction zone of the field-enhancing waveguide. The microwave energy propagates in the direction along the reaction length. The dissociating reactor also features a supply gas inlet where a supply gas is introduced and a process inlet where a process input material is fed into the reaction zone. The supply gas inlet is positioned upstream of the reaction zone. Within the reaction zone, the majority of the supply gas flow occurs parallel to the direction of microwave energy propagation. The supply gas is employed to generate plasma in the plasma zone, converting the process input material into separated components within the reaction zone, with the conversion taking place at a pressure of at least 0.1 atmosphere. An exemplary reactor is described in U.S. Pat. No. 9,767,992, assigned to the assignee of the present application, and incorporated herein by reference in its entirety.

In an embodiment, methane 102 is introduced into the dissociating reactor 104 and dissociated into separate components, namely hydrogen and nanoparticulate carbon, as depicted in FIGS. 1A and 1B. In certain embodiments, the process input material consists of carbon dioxide with water, which is fed into the dissociating reactor 104 and dissociated into separate components, including oxygen, carbon, and water. In alternative embodiments, various other processed materials can be dissociated by the dissociating reactor 104, resulting in different separate components. Further processing of the solid particles, vapors, and liquids generated and emitted by the dissociating reactor 104 can be advantageous. For instance, the solid particles and liquids can be separated from the gases using the electrostatic binning precipitator 200. Solid carbon particles, for example, can be sorted into collection bins based on size, density, and morphology, ensuring that different collection bins receive solid carbon particles with uniform size, density, and/or morphology.

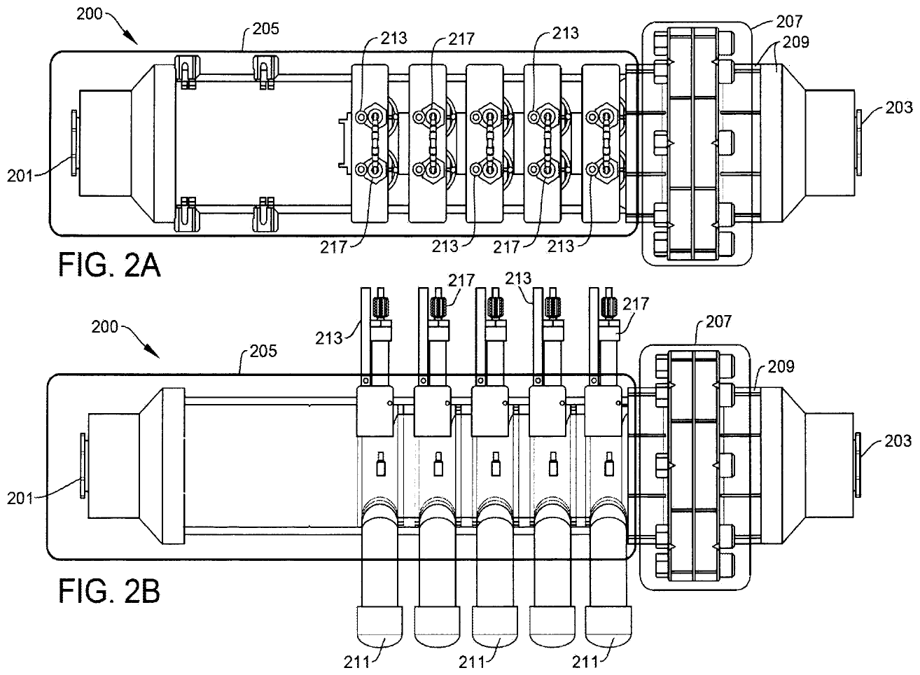

FIG. 2A illustrates a top view of an embodiment of an electrostatic binning precipitator 200 and FIG. 2B shows a side view of the electrostatic binning precipitator 200. The electrostatic binning precipitator 200 can include a particle input 201, a pre-charger portion 231, a binning portion 233, an optional heat exchanger portion 235, and an outlet 203. The input 201, pre-charge portion 231, and binning portion 233 components can be within a heated portion 205 of the precipitator 200, where liquids, gases, vapors, and solid particles are heated to a temperature ranging between approximately 350° C. to 600°° C. This temperature range ensures that liquids entering the precipitator 200 are vaporized, preventing liquids from flowing through the binning portion 233. The heat exchanger portion 235 is located in a cooled portion 207 of the precipitator 200. The cooled heat exchanger portion 235 can reduce the temperature of gases, vapors, and solid particles to below approximately 300° C. This cooler temperature facilitates the separation of liquids from gases before they exit through the outlet 203 of the precipitator 200.

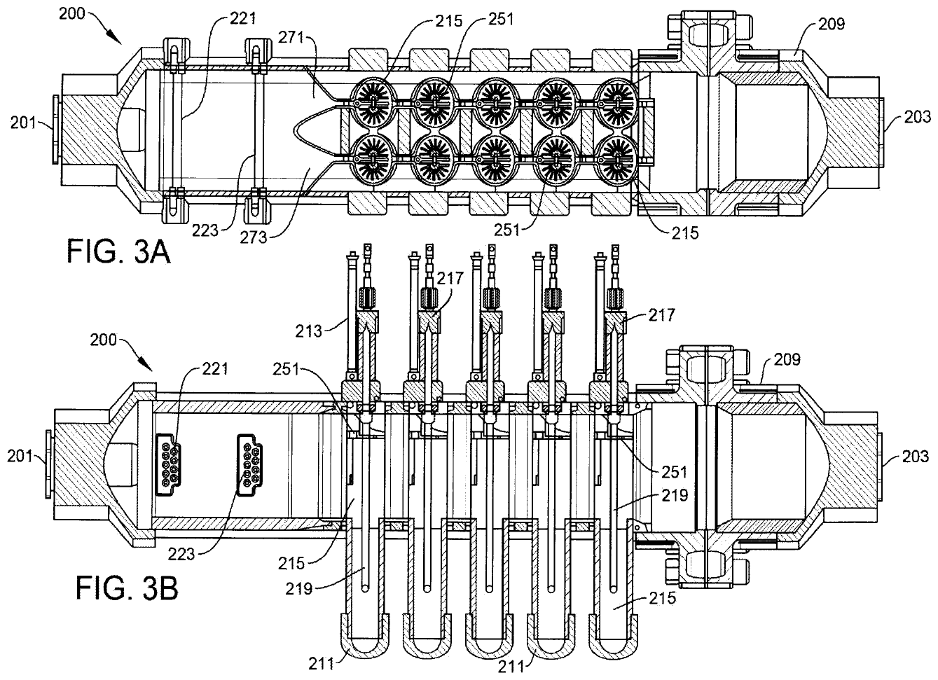

FIG. 3A illustrates a cross section top view of an electrostatic binning precipitator 200 and FIG. 3B illustrates a cross section side view of the electrostatic binning precipitator 200. Solid particles, liquids, vapors, and gas flow through a narrow cross-sectional inlet 201 into a wider cross-section of the precipitator body 202. These components pass through a first unipolar precharge stage 221 and a second unipolar precharge stage 223, where the solid particles are negatively charged by exposed negatively charged wires spanning across the precipitator 200 housing or body.

The solid particles, vapors, and gas then enter the electrostatic cell binning portion 233 of the precipitator 200. In this illustrated embodiment, the electrostatic binning portion 233 can comprise two parallel flow paths 271, 273 that have variable cross sectional areas. In the illustrated embodiment, the flow paths 271, 273 can have vertical channels before and after each of the electrostatic cells. These flow paths can each be significantly narrower and smaller than the wider cross-sectional pre-charge portion 231. Each flow path 271, 273 in the electrostatic cell portion 233 can comprise a sequential series of five electrostatic cells. Each electrostatic cell includes an electrostatic collection mechanism with center electrodes 219 connected to the negative pole of a direct current power supply and a conductive concave cylindrical shell 215 connected to the positive pole of the power supply. The partially concave cylindrical shell 215 partially surrounds the center electrodes 219. The electrical charges on the center electrodes 219 and shells 215 create an electrical field that attracts the charged ionized solid particles to the concave cylindrical surface of the shells 215 through electrostatic forces. The solid particles accumulate on the shells 215 and are removed from the flowing solid particle, vapor and gas stream.

In the presented example, there are two flow paths, 271 and 273, each comprising a first, second, third, fourth, and fifth electrostatic cell collection bin assembly. The center of each sequential adjacent electrostatic cell in the parallel flow paths 271 and 273 can be connected to the same power source. The applied negative voltage of each of the power sources can be adjusted or fine-tuned to enable the collection of solid particles with the same or substantially similar size, density, and morphology in each collection hopper within the binning portion 233 of each electrostatic cell.

Each electrostatic cell can also have a scraper 251 and a scraper actuator 213 that moves the scraper 251 against the shells 215 of the electrostatic cells. When the precipitator 200 is operated, solid particles collect on the shells 215 of the electrostatic cells. Periodically, a scraping process can be performed to move the solid particles from the shells 215 of the electrostatic cells to collection hoppers. The scraping process can include stopping the flow of solid particles, vapors, and gases through the precipitator 200 and turning off the power applied to the electrodes 219 and shells 215 in each electrostatic cell. The scraper actuators 213 can then move the scrapers 251 from the tops of the shells 215 down to the hopper 211 collection area. The solid particles are no longer electrostatically attracted to the shells 215 and can freely fall into the hoppers 211. The scraper actuator 213 can then move the scrapers 251 back to the tops of the shells 215 and the precipitator 200 processing can resume.

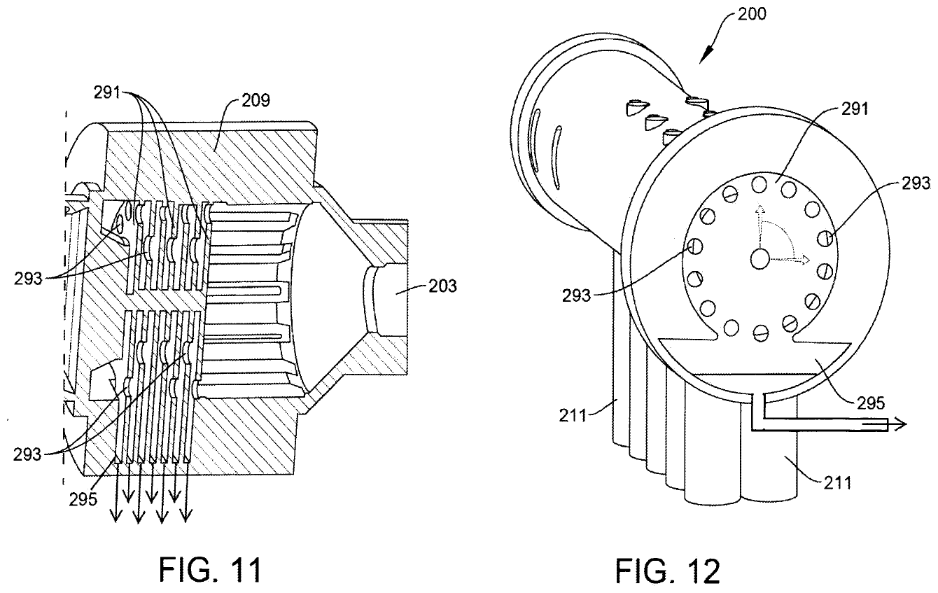

After the electrostatic cell binning portion 233 the remaining vapors and gases and any remaining solid particles can pass through to an optional heat exchanger 209 that can include a plurality of parallel water cooled plates. The cooling in the heat exchanger 209 can cause the vapors in the gas to condense into liquids that can condense on the plates. Liquids and vapors will flow in a convoluted path across each of the water cooled plates. Some of the liquids will attach to the plates and the vapors will contact and condense into liquids on the plates. Gravity will cause the collected liquids to drip down to collection reservoirs. Each of the water cooled plates can have a separate collection reservoir and each reservoir can collect a different hydrocarbon species. The hydrocarbons collected by the cooling plate liquid collector can be used as fuel for an ICE engine, used for other purposes, or disposed of as waste. The cooling plate liquid collector will be described in more detail later with reference to FIGS. 11 and 12. The gases that pass through the cooling plate liquid collector will exit through the outlet 203 of the precipitator 200.

In the illustrated embodiment, the precipitator 200 can have a tubular or cylindrical housing with a circular cross section having an inner diameter that is about 5.7 inches. The shells 215 can form two half pipe concave surfaces that can each have a radius of about 1.0 inch on opposite sides of the electrodes 219. The volumetric flow rate of the particles, liquids, vapor, and gas through the precipitator 200 can be about 100 liters per minute. However, the internal cross sectional area can vary which can cause internal velocity changes, acceleration and deceleration by the solid particles, vapors, liquids, and gases. The velocities of the solid particles, liquids, vapors, and gas can be slow through the precharger and the centers of the electrostatic cells. The velocities can be much faster through the narrower inlet, slots between adjacent electrostatic cells, and the outlet. The particles flowing through the precipitator 200 can spend about 1 to 2 seconds in the enclosed volume of the electrostatic cell shells 215 before flowing to through to the next adjacent electrostatic cell. The size of the precipitator 200 can be scaled based upon the application with a very large cross section for high volume industrial applications and a smaller cross section for smaller scale particle processing.

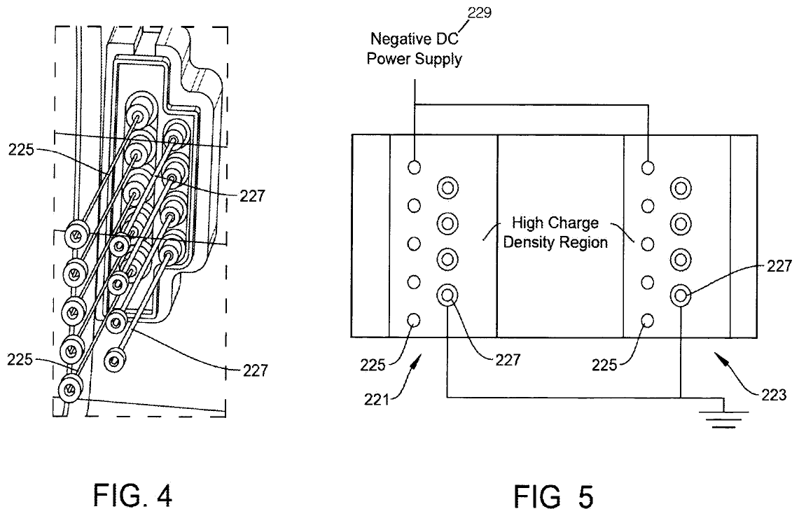

FIG. 4 illustrates a perspective view of an embodiment of a unipolar precharge stage 221. FIG. 5 illustrates an electrical schematic diagram of an embodiment of a unipolar precharge stage 221. In the illustrated embodiment, the unipolar precharge stage 221 can include a plurality of exposed electrically conductive rods or wires 225 and a plurality of insulated electrically conductive rods or wires 227 that extend across the width of the precipitator body. The plurality of exposed rods or wires 225 and the plurality of insulated electrically conductive rods or wires 227 can be parallel and equally spaced vertically from each other. The plurality of exposed rods or wires 225 and the plurality of insulated electrically conductive rods or wires 227 can also be substantially perpendicular to a center line of the precipitator 200.

The insulated electrically conductive rods or wires 227 can be offset in a horizontal downstream position relative to the exposed rods or wires 225. Each insulated electrically conductive rod or wire 227 can be substantially centered vertically between adjacent pairs of the exposed rods or wires 225. The exposed rods or wires 225 can be electrically coupled to a negative pole of a negative direct current (DC) voltage supply 229 and the insulated electrically conductive rod or wire 227 can coupled to a ground (positive) pole of the direct current voltage supply 229 that can be the ground. In some embodiments, the negative voltage applied to the pre-charger electrodes 227, 229 can be negative 10K VDC. In other embodiments, any other suitable voltage can be applied to the electrodes 225, 227.

The insulated positive ground electrodes 227 can be coated with a dielectric layer that can prevent the dissipation of negative ions into the ground. The insulated positive ground electrodes 227 can also increase the ion concentration in the pre-charger stages 221, 223 and subsequently enhances the charging of particles in the submicron size range. As discussed, the purpose of the unipolar precharge stage 221 is to facilitate charging of the solid particles flowing through the precipitator 200 that can result in more effective sorting and collection in the electrostatic cells. This improved charging can result in better solid particle collection efficiency compared with electrostatic precipitators that do not include a pre-charger.

In the illustrated embodiments, each of the unipolar pre-charger sets 221, 223 can consist of five high voltage exposed negative electrodes 225 and four positive insulated ground electrodes 227. In some embodiments, the electrodes 225, 227 can be wires or rods with a diameter of 0.5 mm. The high voltage electrodes are connected to a negative DC power supply 229. The ground electrodes 227 can be coated with a 1 mm thick dielectric layer. The distance between the high voltage electrodes 225 and ground electrodes 227 can be 10 mm.

When the voltage is applied, a high charge electrical fields can be created at the two unipolar pre-charge stages 221, 223. When the precipitator 200 is processing materials, the particles, vapor, and gases enter the inlet and pass across the exposed rods or wires 225. The flow of solid particles through the high charge electrical fields causes the solid particles to be negatively charged. The negatively charged solid particles are then accelerated towards the insulated grounded electrically conductive rods or wires 227 of the first unipolar pre-charge stage 221. This process is repeated at the second unipolar pre-charge stage 223. The flow velocity of the particles through the pre-charger can be controlled to a velocity of 1.0 m/s to ensure sufficient time to negatively charge the particles. The negatively charged particles and gases then enter the electrostatic precipitator binning portion 233 where the negatively charged solid particles are collected.

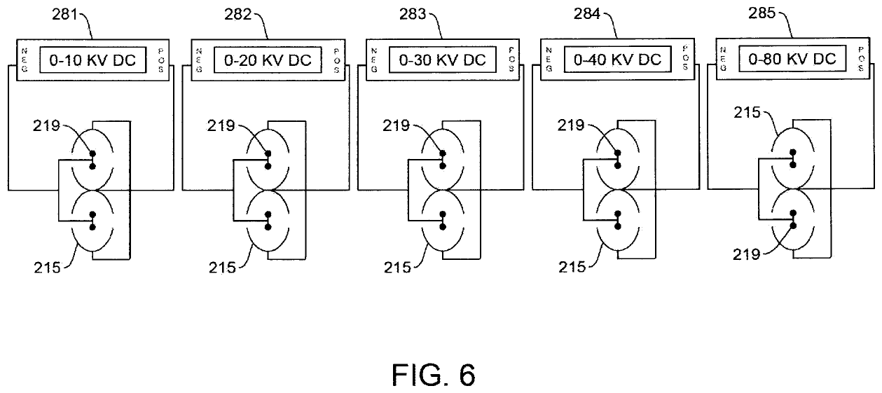

FIG. 6 illustrates a schematic diagram of the electrical systems for two sets of electrostatic cells in a two parallel flow path configuration through the precipitator. In the illustrated embodiment, each flow path can include five electrostatic cells. The first electrostatic cells of both flow paths can use the same power supply 281 to provide electrical current to the negative center electrodes 219 and the shells 215 of the first electrostatic cells. Each of the subsequent sets of adjacent electrostatic cells can use the same independent DC power supplies 282-285 to provide electrical current to the negative center electrodes 219 and the shells 215 of the respective electrostatic cells. In the illustrated embodiment, voltage outputs of the DC power supplies 282-285 are independently controlled and tuned so that each electrostatic cell can collect the desired solid particles. The DC power supplies 282-285 may not have any common electrical connections or alternatively, the independent power supplies 282-285 can have a common earth ground. The power supplies 282-285 can have transformer couplings where the power multiplication performed can be floating compared to each of the other power supplies.

In the illustrated embodiment, each collection bin assembly can have two parallel negative center electrodes 219 in a center portion of each electrostatic cell. The negative center electrodes 219 can be coupled to a negative pole of the power supply and two positive concave half pipe shells 215 can be coupled to a positive pole of the power supply. The concave shells 215 curve about 150-179 degrees around the negative center electrodes 219.

In FIG. 6, each of the independent power supplies 282-285 are illustrated as having very specific DC voltages. However, the power supplies 282-285 can be independently “tuned” to a voltage that is different than the voltages of the other electrostatic cell voltages. Each electrical field in each pair of electrostatic cells can be powered and controlled, independently from the other pairs of electrostatic cells. Each of the independent power supplies 282-285 can be independent power supplies that can all have a common earth ground. The power supplies 282-285 can provide negative voltages to the electrostatic cells and the positive poles can be coupled to a common earth ground. The transformer coupling within each power supply 282-285 where the power multiplication is done and output is floating compared to each other power supply. Existing electrostatic precipitators have only one powered e-field zone for their electrostatic cells. In contrast, the inventive system has multiple electrostatic cells that have different electromagnetic fields that are each independently controlled by the respective independent power supplies 282-285.

Each of the power supplies 282-285 can apply a different net voltage to each of the center electrodes 219 and cylindrical shells 215 in each of the electrostatic cells. The first power supply 281 can output 0-10 KV DC with the center electrodes 219 coupled to the negative pole and the cylindrical shell 215 coupled to the positive pole of the first hopper assembly. The voltage output by the second power supply 282 is 0-20 KV DC, the voltage output by the third power supply 282 is 0-30 KV DC, the voltage output by the fourth power supply 282 is 0-40 KV DC. and the voltage output by the fifth power supply 282 is 0-80 KV DC. Each hopper assembly can collect a different size or range of size particles with smaller particles being collected in the earlier lower voltage hopper assemblies and larger particles being collected in the later higher voltage hopper assemblies. At the pre-charger, the smallest carbon particles can be negatively charged. As the particle filled gas flows into the hopper assemblies, the velocity can slow and the charged particles can be attracted to the positively charged shell 215 of the first hopper assembly where they can be attached. The remaining particles can continue to the second hopper assembly where larger particles are collected. This process can continue for the third and fourth hopper assemblies. The largest expected particles can have a width greater than 20+microns and can be collected in the fifth hopper assembly that can also have the highest applied voltage. TABLE 1 is a listing of voltages and particles size ranges that can be collected at each hopper assembly.

TABLE 1

| | Hopper Assembly | | | | |
|---|---|---|---|---|---|
| | 1 | 2 | 3 | 4 | 5 |
| Voltage DC | 0 to −10 KV | 0 to −20 KV | 0 to −30 KV | 0 to −40 KV | 0 to −80 KV |
| Particle | Less than | 0.5 to 2 μm | 2 to 8 μm | 8 to 20 μm | Greater than |
| Width | 0.5 μm | | | | 20 μm |

The output voltages of the power supplies 282-285 can be adjusted to the voltage that produces the desired particle size and/or morphology collection. Lower net voltages can be used to collect larger particles, while higher net voltages can be used to collect smaller particles. The proper applied voltage or voltages can be determined empirically through experimentation. For example, if the particles collected in the first hopper assembly were measured to be 0.3 μm or less in width, the applied voltage can be increased to 12 KV so that the electrostatic field is increased and larger particles can be trapped. Conversely, if the particles collected in the first hopper assembly were measured to be up to 0.8 μm in width, the applied voltage can be lowered so that the electrostatic field is decreased to 8 KV so that larger particles can pass through to the second hopper assembly. Once the desired constant or pulsed voltages for each of the electrostatic cells are determined, they can become the normal predetermined operating voltages for the system.

During normal precipitator operations, the power supplies 282-285 can output their normal voltages as either a constant voltage or a pulsed cyclical voltage. However, the power supplies 282-285 can be turned off with 0 VDC applied when particle flow through the precipitator system is stopped and/or the particle collection scrapers are actuated to sweep particles into the collection hoppers. When the particle collection is completed and the scrapers are returned to their normal position, the power supplies 282-285 can turned on to output their normal predetermined voltages to the electrostatic cell electrodes and the particle flow through the precipitator system can be resumed.

Industrial electrical power is more commonly available for industrial use as alternating current (AC). The power supplies for the electrostatic precipitator 200 can convert the industrial ac voltage (220 to 480 V) to non-pulsating or pulsating de voltages. The power supplies can consist of a step-up transformer, high-voltage rectifiers, and sometimes filter capacitors. The power supplies may supply either half-wave or full-wave rectified de voltage. Auxiliary components and controls can allow the voltage to be adjusted without excessive sparking and to protect the supply and electrodes in the event a heavy arc or short-circuit occurs.

In some embodiments, thyristors with solid state relays (SSR) can be used to convert the AC power into the high voltage DC for the pre-charger power supply 229 and the electrostatic power supplies 282-285. The SSRs can consist of a sensor which responds to an appropriate input (control signal), an electronic switching device which switches power to the electrostatic load circuitry, and a coupling mechanism to enable control signal activation. The SSRs can use thyristors to switch the applied currents up to hundreds of amperes.

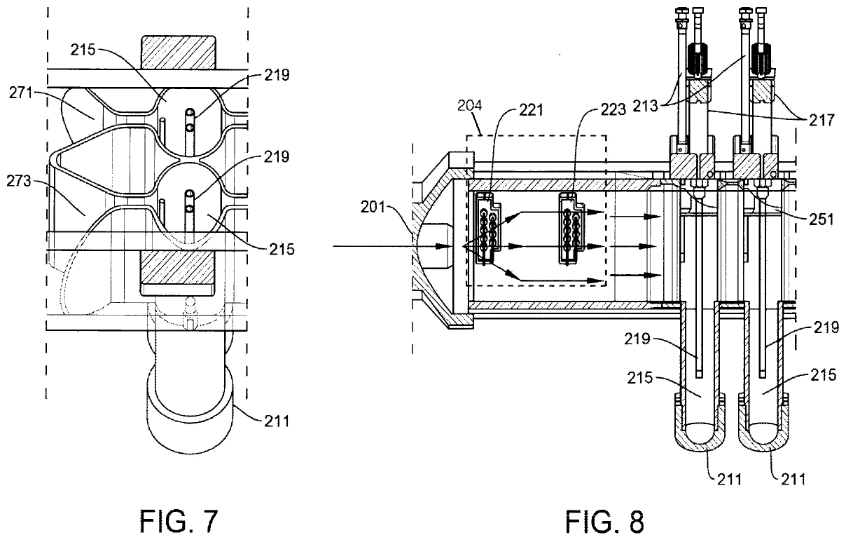

FIG. 7 illustrates a perspective cross-section view of the first electrostatic cells in the two flow paths 271, 273. In the illustrated embodiment, the cross section of the precipitator body can be circular while the collection bin flow paths 271, 273 can narrow into thin vertical slots. The illustrated electrostatic cells can each have two parallel negative charge electrodes 219 and two cylindrical shells 215. The electrodes 219 and cylindrical shells 215 can be vertically aligned and extend across the height of the precipitator body. The flow path cross sectional areas can then increase from the inlets to the centers of the electrostatic shells 215 and then narrow into thin vertical slots from the centers to the outlets of the electrostatic shells 215. This contraction and expansion of the flow path cross sectional areas can result in variable velocities for the solid particles in the gas streams as they flow through the electrostatic cells. More specifically, the particles can accelerate through the narrow inlet and then slow at the larger cross section pre-charger. The particles can then accelerate to a higher velocity through the narrow slots and then slow again at the centers of each of the electrostatic cells. By slowing the particle velocities at the cylindrical shells 215, the collection of the solid particles in each of the electrostatic cells is improved since the slower moving solid particles are more easily trapped than faster moving solid particles.

FIG. 8 illustrates a cross section side view of the inlet 201, the pre-charge section 204 and the first and second electrostatic cells. After the particles enter the precipitator through the inlet 201, they pass through the first pre-charger 221 and then through the second pre-charger 223 where the solid particles are negatively charged and heated. The particles can be distributed across the cross section of the interior volume of the precipitator body before flowing into the first set of electrostatic cells. The electrostatic cells can each have electrodes 219 and cylindrical shells 215 can be vertically aligned and extend across the height of the precipitator body.

The smaller solid particles can be attached to the positively charged shell 215 of the first pair of electrostatic cells having a lower net voltage power supply. Larger solid particles can pass through narrow vertical slots to the second pair of electrostatic cells where some of the larger solid particles can be attached to the positively charged shell 215 of the second electrostatic cells having a higher net voltage power supply. Some of the solid particles can continue to flow through to the remaining electrostatic cells and described process can continue with each subsequent electrostatic cell having a higher net voltage power supply. In the illustrated embodiment, the fifth pair of electrostatic cells can have a significantly higher net voltage power supply which can be used to collect substantially all remaining solid particles on the positively charged shell 215 so that only gas, vapor, and liquids exit the precipitator.

In the illustrated embodiment, the positively charged shells 215 can extend vertically from the top through to the bottom of the precipitator housing 202 and into collection hoppers 211 that can extend below the precipitator housing 202. Each collection bin assembly can have a scraper 251 coupled to a scraper actuator 213 mechanism that can be used to move the scraper 251 within the electrostatic cells. During normal use, the particles flow into the precipitator and accumulate on the interior exposed surfaces along the length of the shell 215 and within the lower collection hoppers 211. The scrapers 251 can be circular, oval, or other shaped structures having outer edges that contact the inner surfaces of the shells 215. The scrapers 251 can normally be in a raised position so that the scrappers 251 do not interfere with the particle and fluid flow through the precipitator or the collection of particles in the collection bins. The particles collected on the shell 215 can degrade particle collection performance or prevent further collection of particles by the electrostatic cells. The inner surfaces of the shells 215 can be cleaned with the scrapers 251 to restore the particle collection performance of the electrostatic cells.

In order to clean the particles from the surfaces of the shells 215 a scraping and particle collection process can be performed. The gas and particle flow through the precipitator can be stopped and the applied voltage to each of the collection bins can be turned off. Because the voltages are no longer applied, the solid particles are no longer electrostatically attracted to the shells 215 and the particles can fall into the collection hoppers 211. The scrapers 251 can be moved down the shells 215 by actuating the scraper actuator 213. As the scrapers 251 moves down the shells 215, the scrapers 251 can move and the outer edges of the scrapers 251 can sweep the solid particles collected on the shells 215 down into the collection hoppers 211. Once the scraping of the shells 215 is complete, the scraper actuator 213 can move the scraper 251 back to the normal raised position away from the fluid flow path through the precipitator. The gas, particle, and vapor flow through the precipitator can resume and normal predetermined voltages can be reapplied to the electrostatic cells again.

In the illustrated examples, caps are placed on the ends of the collection hopper 211 tubes. In other embodiments, particle delivery tubes can be coupled to the ends of the collection hopper 211 tubes so that the collected solid particles can be delivered to desired locations for further processing and/or storage. The collected solid particles can be moved with a gas flow from the precipitator through the particle delivery tubes to the particle processing and/or particle storage areas. In some embodiments, a vacuum can be applied to the particle delivery tubes to facilitate the solid particle transportation from the collection hoppers 211 to the processing and/or particle storage areas. As discussed, all solid particles in the gas, can be collected into the collection hoppers 211 of the electrostatic cell portion 206.

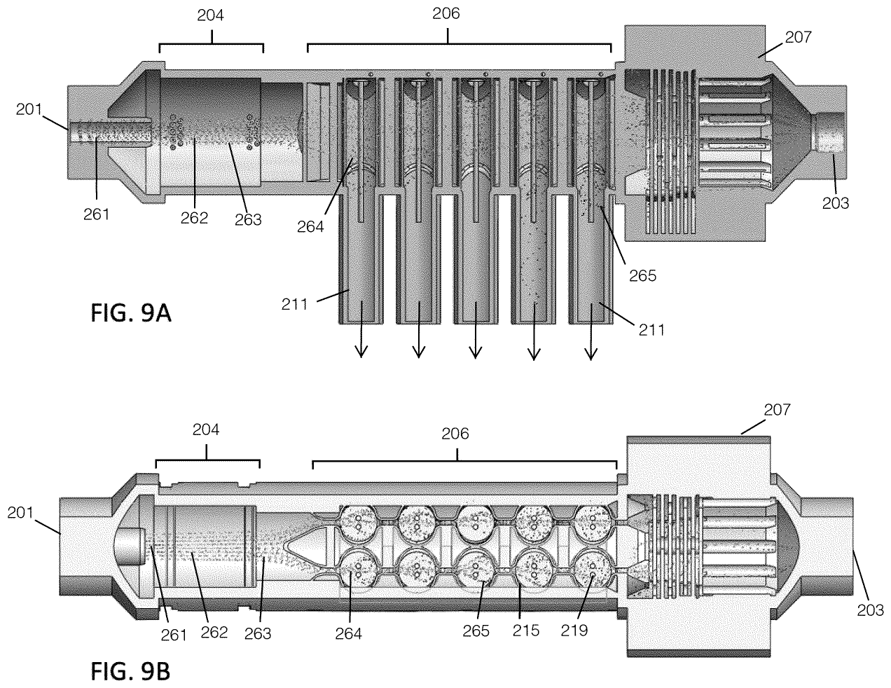

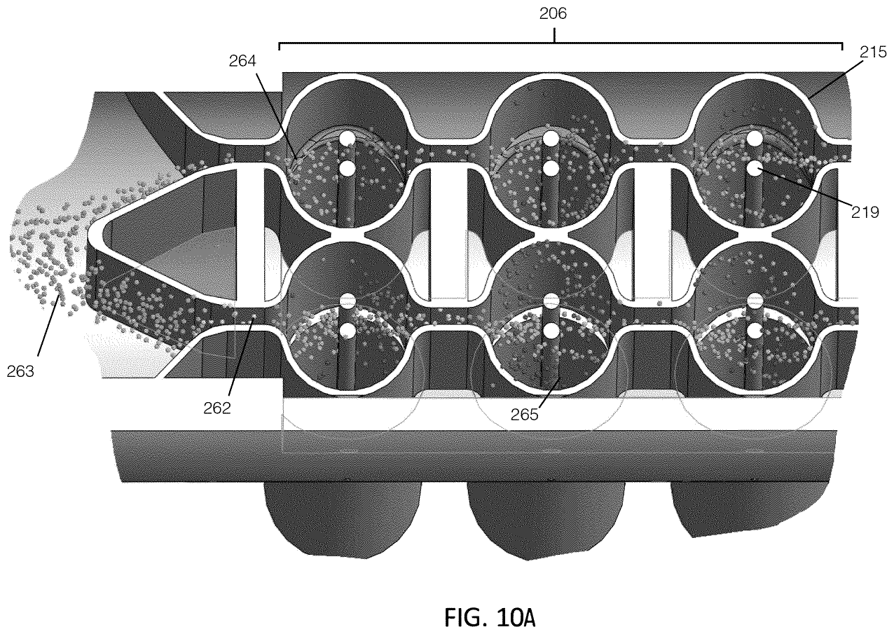

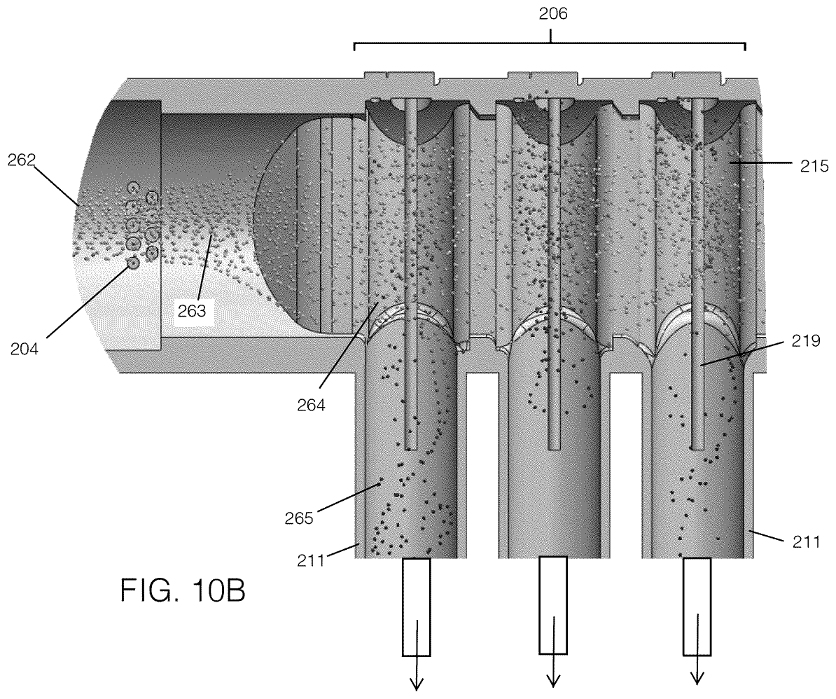

As discussed, the velocity of the gases, vapor, and particles can vary as they travel through the precipitator. FIG. 9A illustrates a side cross section view and FIG. 9B illustrates a top cross section view of color coded particles traveling through the precipitator 200. FIG. 10A illustrates a cross section top perspective view of an embodiment a precipitator showing particle velocities through the first three electrostatic cells. FIG. 10B illustrates a cross section side view of an embodiment a precipitator showing particle velocities through the first three electrostatic cells. The color coding can indicate the velocity of the gas, vapor, and solid particles as indicated in Table 2 below.

TABLE 2

| Color | Red | Yellow | Green | Light Blue | Dark Blue |
|---|---|---|---|---|---|
| Relative | Fastest | Medium | Medium | Medium | Slowest or |
| Velocity | | Fast | | Slow | Stopped |
| Velocity | >10 | 10-4 | 4-2 | 1-2 | <1 |
| | inch/sec | inch/sec | inch/sec | inch/sec | inch/sec |

The colored particles 261-265 shown in FIGS. 9A-10B can include gas, vapor, and solid particles. The gas. vapor, and solid particles can enter the narrow inlet 201 as indicated by the red high speed particles 261. The cross section of the precipitator 200 can then expand at the pre-charging portion 204, which causes the gas, vapor, and particles to slow down in horizontal velocity through the precipitator 200. Some of the gas, vapor. and solid particles at the center of the precipitator 200 can be red fastest particles 261 while the velocities can decrease at areas away from the center of the precipitator. Some yellow medium fast 262 are shown on opposite sides of the center stream of red fastest particles 261 and some green medium speed particles 263 are shown on opposite sides of the yellow medium fast particles 262.

As the gas, fluids and particles flow through the narrow vertical grooves before the hopper assemblies, the particle velocities can increase as illustrated by the yellow particles 262 and green particles 263 in these areas of the precipitator 200. As the flow path cross sections expand at each of the cylindrical shells 215 of the electrostatic cells, the velocity decreases as indicated by the light blue 264 at center flow paths and the dark blue 265 in each of the electrostatic cells. The dark blue slow particles 265 include solid particles that are electrostatically attached to the cylindrical shells 215 and collected by each of the hoppers 211. As discussed, the solid particles can be pushed by a scrapper to the bottom of the electrostatic cells into collection bins. The solid particles can be pure carbon that is then be moved from the hoppers 211 to other locations for further processing or used as raw materials for the fabrication of other structures such as fuel cells, carbon parts, carbon panels, and other structures.

The particles that pass through the electrostatic cells can accelerate through the vertical slots between the adjacent electrostatic cells as illustrated by the yellow particles 262 and green particles 263 and then decelerate at the cylindrical shells 215 of the next electrostatic cell as illustrated by the light blue particles 264 and dark blue particles 265. Ideally, substantially all of the solid particles will be collected in the electrostatic cells with each hopper 211 collecting a different uniformly sized solid particle. As discussed, the first lower net voltage electrostatic cells can collect smaller sized carbon particles, while the later net higher voltage electrostatic cells can collect larger sized carbon particles. The remaining particles that exit the electrostatic cell portion 206 may only include vapors and gases.

When the vapors and gases reach the heat exchanger 207, they can slow in velocity as illustrated by the light blue particles 264 and dark blue particles 265 on and between each of the adjacent planar vertical cooling plates. The heat exchanger 207 can be water cooled to condense the liquids from the vapors on the heat exchanger 207 plates. Some of the vapors and gases slow or stop as indicated by dark blue 265. The vapors and gases can condense as liquids that can fall into liquid condensation collection areas 295 of the heat exchanger 207. Each of the water cooled plates can have a separate collection reservoir and each reservoir can collect a different hydrocarbon species. The hydrocarbons can be used as fuel for an ICE engine or alternatively the collected liquids can be used for other purposes or disposed of as industrial waste.

In some embodiments, the average flow velocity of the particles through the pre-charger can be controlled to a velocity of 1.0 m/s. The charged particles then pass through to the binning portion 233. The average flow velocity of the gases through the binning section of the ESP can be 0.25 m/s, and the residence time of the solid particles, vapors and gases passing through the binning section of each electrostatic cell can be about 2.4 s.

After flowing through the electrostatic cell portion 206, the gas can exit the outlet of the precipitator or flow into an optional cooling plate liquid collection portion of the precipitator. FIG. 11 illustrates a cross section side view of an embodiment of a water cooled plate heat exchanger that functions as a liquid collector and FIG. 12 illustrates a cross section rear view of one of the baffle plates 291 of the heat exchanger 209.

At the heat exchanger portion of the precipitator, vapors in the gas can be condensed into liquids can be separated from the gas that can then exit the outlet of the precipitator 200. The plate heat exchanger can include a plurality of vertical planar baffle plates 291 that can each have offset flow holes 293 or other fenestrations. Each of the vertical planar water-cooled baffle plates 291 can be thin structures that are close to each other in a parallel configuration.

The gas and vapor particles entering the heat exchanger can be very hot and the heat from the gas and vapor can be transferred to the baffle plates 291 by thermal convection. The heat can then be transferred from the baffle plates 291 to the metal portions of the heat exchanger 209 by thermal conduction and eventually to the moving cooling liquid flow paths by thermal convection. The precipitator heat exchanger 209 can have external and/or internal cooling flow paths through which a cooling liquid such as water or other thermally conductive liquids. The heated cooling water flowing through the heat exchanger 209 can then be cooled through an external cooling water heat exchanger. The cooled water can then be pumped back into the heat exchanger 209. The precipitator heat exchanger can be made of a thermally conductive material such as aluminum, titanium, steel, or other metal or alloy materials.

The gases and vapors can contact travel in a horizontal direction into the first perpendicular baffle plate 291. Some of the vapors can condense into a liquid on the first baffle plate 291 and flow down into a first reservoir 295 liquid collection area. The gas and uncondensed vapor can then flow through the holes 295 in the first baffle plate 291 and contact the second baffle plate 291. Some of the vapors can condense into a liquid on the second baffle plate 291 and flow down into a second collection area 295. This process can be repeated for each of the remaining baffle plates 291 as the gas flow through the heat exchanger. Ideally, all of the vapor can be removed from the gas in the liquid collection reservoirs 295 and the gas can flow through the outlet 203 of the precipitator 200.

In some embodiments, a PAH (polyaromatic hydrocarbon) laden gas stream is being processed by the precipitator and is cooled by the liquid collection portion after the particle separation. The described liquid collection processing can drop the vaporized PAH's out of vapor phase and into liquid phase where they are collected into lower reservoirs upstream of each of the baffle plates where the PAH liquids can be collected. The PAH liquids can be removed from the reservoirs and sent out for industrial reuse or alternatively, the PAH liquids can be processed as industrial waste.

Substantially all solid particles can be removed by the electrostatic cells and substantially all vapors will condense in the heat exchanger 207 and also be removed from the particles flowing through the precipitator 200. The remaining gases can flow out of the heat exchanger 207 and accelerate in velocity through the smaller cross section outlet 203 as shown by the green particles 263 at the exit the precipitator 200. The gases can be separated into hydrogen gas and other gases by filtration or other separation mechanisms.

In some situations, solid particles and vapors may exit the precipitator 200. A solid particle and/or vapor sensor can be mounted on the outlet 203. If particles or vapors are detected in the gas exiting the precipitator the system may not outlet all of the particles may not have been removed and/or all of the vapors may not have been condensed from the gases. The solid particles and/or vapors can be diverted back to the inlet 201 for reprocessing by the precipitator has illustrated in FIGS. 1A and 1B.

The present disclosure, in various embodiments, includes components, methods, processes, systems, and/or apparatus substantially as depicted and described herein, including various embodiments, subcombinations, and subsets thereof. Those of skill in the art will understand how to make and use the present disclosure. The present disclosure, in various embodiments, includes providing devices and processes in the absence of items not depicted and/or described herein or in various embodiments hereof, including in the absence of such items as may have been used in previous devices or processes, e.g., for improving performance, achieving ease, and/or reducing cost of implementation. Rather, as the following claims reflect, inventive aspects lie in less than all features of any single foregoing disclosed embodiment.

What is claimed is:

1. An electrostatic precipitator comprising:
a precipitator body having an inlet upstream of an outlet;
a plurality of electrostatic cells in the precipitator body, at least two of the plurality of electrostatic cells having an electrode extending across the precipitator body, a concave electrode shell adjacent to the electrode, a particle collection portion, and a voltage source applying a net voltage between the electrode and the concave electrode shell;
a flow path through the inlet, the plurality of electrostatic cells, and the outlet;
wherein a first electrostatic cell of the electrostatic cells is upstream of a second electrostatic cell of the electrostatic cells and a first net voltage output from the voltage source of the first cell is lower than a second net voltage output by the voltage source of the second electrostatic cell.

2. The electrostatic precipitator of claim 1 wherein the second electrostatic cell of the electrostatic cells is upstream of a third electrostatic cell of the electrostatic cells and a third net voltage output by the voltage source of the second electrostatic cell is lower than the second net voltage output by the voltage source of the third electrostatic cell.

3. The electrostatic precipitator of claim 1 further comprising:
a first slot cross section passageway in the precipitator body upstream of the first electrostatic cell; and
a second slot cross section passageway in the precipitator body between the first electrostatic cell and the second electrostatic cell;
wherein the flow path is through the inlet, the plurality of electrostatic cells, the first slot cross section passageway, and the second slot cross section passageway, and the outlet.

4. The electrostatic precipitator of claim 1 further comprising:
a unipolar pre-charger in the precipitator body upstream of the electrostatic cells, the unipolar pre-charger having pre-charger electrodes that extend across the precipitator body.

5. The electrostatic precipitator of claim 1 further comprising:
a heater for heating the unipolar pre-charger and the electrostatic cells.

6. The electrostatic precipitator of claim 1 further comprising:
a heat exchanger in the precipitator body downstream of the electrostatic cells.

7. The electrostatic precipitator of claim 5 wherein the heat exchanger is water cooled and the heat exchanger has a plurality of parallel plates and a fluid collection reservoir for collecting condensed liquids.

8. The electrostatic precipitator of claim 1 wherein the at least two of the electrostatic cells include a scraper coupled to an actuator for moving the scraper along the length of the concave electrode shell between a raised position and a lowered position in or adjacent to the particle collection portion.

9. The electrostatic precipitator of claim 1 wherein the net voltage output by the voltage source of the first cell is less than 50 KV DC and the net voltage output by the voltage source of the second electrostatic cell is greater than 50 KV DC.

10. The electrostatic precipitator of claim 1 wherein particles flow into the flow path are collected in the particle collection portion of the electrostatic cells and the particles collected in the particle collection portion of the first cell are larger than the particles collected in the particle collection portion of the second electrostatic cell.

11. An electrostatic precipitator comprising:
a precipitator body having an inlet upstream of an outlet;
a first set of electrostatic cells and a second set of electrostatic cells in the precipitator body, at least two of the first set of electrostatic cells and at least two of the second set of electrostatic cells having an electrode extending across the precipitator body, a concave electrode shell adjacent to the electrode, a particle collection portion, and a voltage source applying a negative voltage between the electrode and the concave electrode shell;
a first fluid flow path through the inlet, the first set of electrostatic cells, and the outlet; and
a second fluid flow path through the inlet, the second set of electrostatic cells, and the outlet;
wherein the first set of electrostatic cells is parallel to the second set of electrostatic cells.

12. The electrostatic precipitator of claim 11 wherein a first electrostatic cell of the first set of electrostatic cells is upstream of a second electrostatic cell of the first set of electrostatic cells and the net voltage output of the first cell is lower than the net voltage output of the second electrostatic cell.

13. The electrostatic precipitator of claim 11 wherein the second electrostatic cell is upstream of a third electrostatic cell of the first set of electrostatic cells and the net voltage output of the second electrostatic cell is lower than the net voltage output of the third electrostatic cell.

14. The electrostatic precipitator of claim 11 further comprising:
a first slot cross section passageway in the precipitator body upstream of the first electrostatic cell in the first fluid flow path; and
a second slot cross section passageway in the precipitator body between the first electrostatic cell and the second electrostatic cell in the first fluid flow path.

15. The electrostatic precipitator of claim 11 further comprising:
a unipolar pre-charger in the precipitator body upstream of the first set of electrostatic cells and the second set of electrostatic cells, the unipolar pre-charger having pre-charger electrodes that extend across the precipitator body.

16. The electrostatic precipitator of claim 11 further comprising:
a heater for heating the unipolar pre-charger and the first set of electrostatic cells and the second set of electrostatic cells.

17. The electrostatic precipitator of claim 11 further comprising:
a heat exchanger in the precipitator body downstream of the first set of electrostatic cells and the second set of electrostatic cells.

18. The electrostatic precipitator of claim 17 wherein the heat exchanger is water cooled and the heat exchanger has a plurality of parallel plates and a fluid collection reservoir for collecting condensed liquids.

19. The electrostatic precipitator of claim 11 wherein the at least two of the first set of electrostatic cells and the at least two of the second set of electrostatic cells include a scraper coupled to an actuator for moving the scraper along the length of the concave electrode shell between a raised position and a lowered position in or adjacent to the particle collection portion.

20. The electrostatic precipitator of claim 11 wherein the net voltage output by the voltage source of the first cell is less than 50 KV DC and the net voltage output by the voltage source of the second electrostatic cell is greater than 50 KV DC.
